(19) United States
(12) Patent Application Publication
(10) Pub. No.: US 2013/0300298 A1
(43) Pub. Date: Nov. 14, 2013

(54) ULTRASONIC MOTION SENSOR DEVICE

(71) Applicant: Steinel GmbH, Herzebrock (DE)

(72) Inventor: Thomas Moeller, Herford (DE)

(21) Appl. No.: 13/886,648

(22) Filed: May 3, 2013

(30) Foreign Application Priority Data
May 8, 2012 (DE) 20 2012 101 683.4

(51) Int. Cl. H05B 37/02; G01S 15/50

(52) U.S. Cl. CPC H05B 37/0227; G01S 15/50
USPC 315/152; 367/93

(57) ABSTRACT

An ultrasonic motion sensor device for lighting control, having a housing (10), preferably designed for ceiling-mounting, at least one ultrasonic transducer (11, 14) arranged in the housing (10) for sending and/or receiving ultrasonic waves through a housing opening associated with the ultrasonic transducer (11, 14), and having a control device (9) associated with the ultrasonic transducer (11, 14). The opening in the housing is formed by a horn which is spaced apart from the ultrasonic transducer (11, 14) via a resonator cavity arranged in the housing (2) and an impedance opening (21) is provided, preferably bounded by the horn, which the emitted and/or received ultrasonic waves (11, 14) are to pass through, the cross-sectional area (18) of which is less than a maximum cross-sectional area of the resonant cavity and than a maximum cross-sectional area of the horn.

### BACKGROUND OF THE INVENTION

The invention relates to an ultrasonic motion sensor device, preferably designed for ceiling mounting, for controlling lighting, and to a lighting system.

Ultrasonic sensor devices for lighting control in buildings are well known. These comprise pulsed ultrasonic transducers for emitting ultrasonic waves at a first pulse rate, and for receiving reflected ultrasonic waves at a second pulse rate. The ultrasonic transducer is associated with a control device, which on recognition of a frequency shift, detects a motion and activates or deactivates a lamp as a response thereto. Known ultrasound motion alarms have the problem that the ultrasonic waves also propagate into other areas, for example through open doors into neighbouring rooms, so that movements are also detected there. This is particularly problematic in elongated spaces, e.g. corridors, including school corridors, where as a result of the long length a plurality of ultrasonic sensors is required to cover the entire space and in addition, a plurality of doors normally opens into the elongated space, for example such that if one of the doors is open, movements in the adjoining rooms lead to an undesirable activation of the corridor lighting.

Starting from the above-mentioned prior art, the problem addressed by the invention is to specify an ultrasonic movement alarm for controlling lighting which is preferably suitable for and designed for ceiling-mounting, and which is designed for use in elongated spaces, in particular in corridors, and which achieves a large range (detection range), wherein the ultrasonic motion sensor device is to be designed in such a manner that any propagation of the ultrasonic waves into neighbouring rooms is prevented, at least to a large extent. It is also preferred if the ultrasonic movement sensor has a simple, preferably modular, design.

### SUMMARY OF THE INVENTION

The foregoing problem is solved by means of an ultrasonic motion sensor device of the present invention based on the idea of designing the ultrasonic sensor device for lighting control such that it has a comparatively directed emission and/or reception characteristic, in order therefore to generate a detection range which is elongated and narrow in relation thereto. This ensures that on the one hand, elongated areas, in particular corridors, can be monitored with a small number of such ultrasonic motion sensor devices, and on the other hand prevents ultrasonic waves being propagated into areas, in particular into adjacent rooms perpendicular to the main emission direction, thus preventing erroneous triggering of the lighting. According to the invention this is achieved by the fact that a horn (i.e. a funnel-shaped or trumpet-shaped outlet) is assigned to the at least one ultrasonic transducer, piezo-transducer or, more preferably, a quartz transducer, wherein according to the invention this horn does not directly adjoin the ultrasonic transducer, but is spaced apart from it by a resonant cavity (reflex chamber) to optimize the directional characteristics and filtering of the ultrasonic waves.

Furthermore, it is provided according to the invention that the maximum cross-sectional area of the preferred resonant cavity oriented perpendicular to the spacing direction between horn and ultrasonic transducer is greater than the cross-sectional area, preferably oriented parallel thereto, of a preferably circular impedance opening which the ultrasonic waves must pass through on their way between the ultrasonic transducer and the outer end of the horn, preferably implemented as a tractrix horn. The combination of horn and resonant cavity results in an efficient coupling of the ultrasonic transducer to the transmission medium, air, so that an optimal directivity/directional characteristic is obtained.

This further results in a high efficiency and hence a large range, since the above combination provides a focussing of the ultrasonic waves, resulting in a large range of the ultrasound while at the same time minimizing undesired propagation perpendicular to the main emission direction. The ultrasonic motion sensor device according to the invention is particularly suitable for use in long, narrow spaces, such as walkways and corridors and/or for the detection of temporarily present solid objects, for example, cars in parking spaces of car parks.

As mentioned above, the focussed and directed ultrasonic wave prevents it from being detected in adjacent areas, in particular rooms, parking spaces or the like, and therefore ensures a selective detection of objects or movements.

It is particularly preferred if the maximum cross-sectional area mentioned above is realized not only in a short axial section of the resonant cavity, but if an axial section continuously having the maximum cross-sectional area extends over the majority of its longitudinal extension, wherein it is further preferred that the maximum cross-sectional area is circular in shape, that is, formed from a cylindrical section of the resonant cavity.

It has proved particularly advantageous if the cross-sectional area ratio between the cross-sectional area of the impedance opening and the maximum cross-sectional area of the resonant cavity is selected from a range of values between approximately 0.2 and approximately 0.3, preferably between approximately 0.22 and approximately 0.26, and preferably has a value of approximately 0.24. Ideally, the emitted ultrasound frequency of the ultrasonic transducer at the above cross-sectional area ratio lies between approximately 35 kHz and 45 kHz and particularly preferably is at least approximately 40 kHz. For this purpose a quartz ultrasonic oscillator is preferably used as the ultrasonic transducer. In the case of circular cross sectional areas the diameter ratio is preferably 1:2.

In order to obtain a maximally simple and easy-to-assemble motion detector, it is advantageous to extend the invention by providing the at least one ultrasonic transducer with an associated holder which is fixed onto a circuit board of the control device. It is especially advantageous if the holder is a plastic injection-moulded part, which is further preferably configured such that it can be clipped onto the printed circuit board.

Concerning the design of the resonant cavity, in terms of obtaining a simple design of the device it has proved to be particularly advantageous if this is bounded, at least in some sections, by an adapter piece constructed as a plastic injection-moulded part. The adapter piece preferably has a sleeve-like construction and is arranged between the horn, which is preferably formed from a section of the housing, and the ultrasonic transducer. In the assembled condition the adapter is preferably connected to the holder for the ultrasonic transducer and/or the horn using a positive fit, it being particularly advantageous if the adapter, with regard to facilitating its assembly, can be placed on a corresponding projection, in particular an annular collar, of the holder for the ultrasonic transducer.

It is also preferred if the horn axially protrudes a short distance into the adapter.

As already previously indicated, with regard to facilitating assembly it is particularly preferable if the at least one horn is formed in a housing shell made from plastic. In other words, the horn is preferably formed by the housing of the device, wherein the housing shell from which the horn is moulded is preferably implemented as a plastic injection-moulded part.

In principle, it is possible to operate the ultrasonic transducer in clocked mode, thus as both sender and receiver, in which case in a first clock cycle it converts an electrical signal into ultrasonic waves and in a second cycle converts received ultrasonic waves into an electrical signal.

As the clock periods would have to be chosen to have relatively large values, owing to the wavelength of the ultrasonic waves, such a design would lead to relatively long dead times in which no motion detection is possible. In order to avoid this, in an extension of the invention at least one pair of ultrasonic transducers is provided, each with a resonant cavity and a horn, wherein the horns are at least approximately oriented in a common direction. Preferably, for this purpose the horns are arranged or aligned in parallel, wherein it is particularly advantageous if the horns of a horn pair are formed by a common housing shell, each resonant cavity being further preferably bounded, at least in some sections, by an adapter piece positioned between the respective horn and the associated ultrasonic transducer. One ultrasonic transducer of the pair is used as a transmitter and the other ultrasonic transducer as the receiver.

It is particularly preferred if the two resonant cavities as well as the two horns of a pair have identical dimensions.

To be able to detect movements in two different directions, preferably facing approximately away from each other, in an extension of the invention it is advantageously provided that the sensor attachment has two pairs of ultrasonic transducers, making a total of four ultrasonic transducers with associated resonant cavities and horns, wherein it is most particularly preferred that each pair of horns is formed from a common housing shell. It has proved to be particularly advantageous if the at least one housing shell, forming at least one horn, is fixable by means of a further housing shell, in which case it is particularly preferred if a total of two housing shells, each having two horns, are arranged on sides of the housing facing away from each other and are held using another, central, housing shell. All of the above housing shells are preferably designed to be lockable to make them simpler to mount, in particular on the printed circuit board and/or on a circumferential housing framework piece.

### BRIEF DESCRIPTION OF THE DRAWINGS

Further advantages, features and details of the invention can be found in the following description of preferred exemplary embodiments and from the drawings. These show:

FIG. 1 a perspective view of an ultrasonic motion sensor device from the outside,

FIG. 2 a detail of the device according to FIG. 1, comprising a printed circuit board and a pair of ultrasonic transducers with associated resonant cavities and horns,

FIG. 3 the structure of a combination of ultrasonic transducer, adapter and horn, in a cross-sectional view, and

FIG. 4 a perspective view of an opened ultrasonic sensor device, in which components are omitted to clarify the structure.

In the figures equivalent elements and elements with the same function are assigned the same reference numeral.

### DETAILED DESCRIPTION

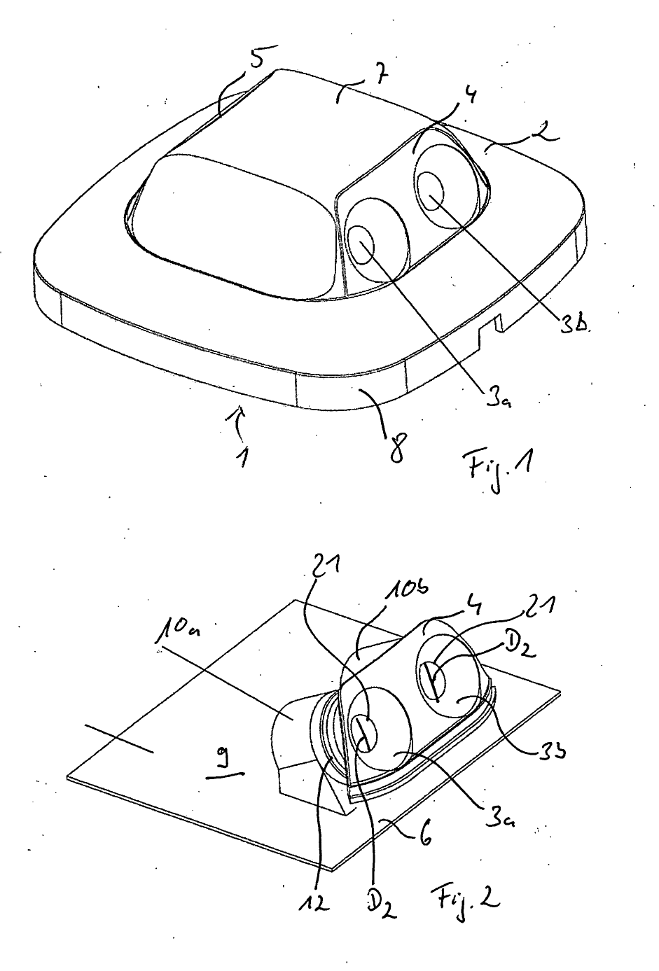

FIG. 1 illustrates a motion sensor device 1, shown rotated by 180° opposite to the direction of mounting on a ceiling. This comprises a housing 2 assembled from a plurality of plastic injection-moulded parts, in which housing a total of four horns are constructed, with only one pair of horns 3a, 3b being shown in the illustration.

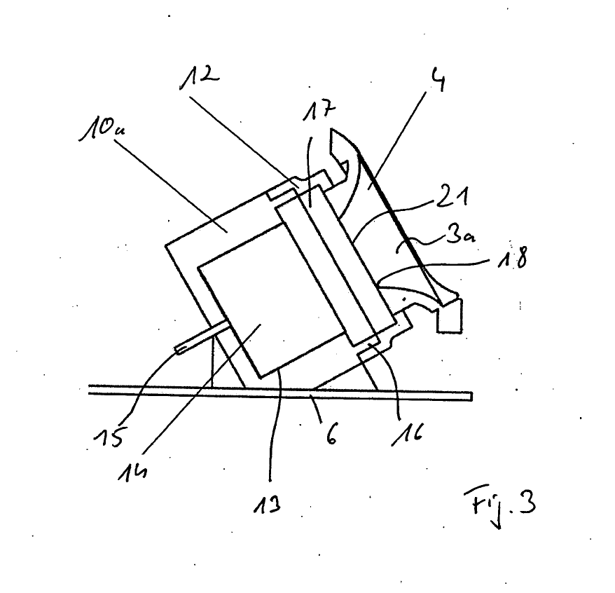

In the exemplary embodiment shown the housing 2 comprises two lateral housing shells 4, 5, arranged so that they face away from each other, which are implemented as plastic injection-moulded parts and which enclose an angle with a base surface of the device 1, and thus with a printed circuit board 6 shown in FIG. 2, such that in relation to a mounting position the horn pairs are directed downwards at an angle, wherein the horn pairs are arranged in different directions.

At the same time the housing shells 4, 5 form the horns, which are moulded into the former, wherein each housing shell 4, 5 forms one pair of horns 3a, 3b. The housing shells 4, 5 are overlapped by a central housing shell 7, which also acts as a fixing for the lateral housing shells 4, 5. In a lower region, all of the housing shells 4, 5, 7 are overlapped by a circumferential frame 8.

The central shell 7 is clipped to the circumferential frame 8 and fitted as a single unit over the whole assembly consisting of printed circuit board 6, horn 3a, 3b, adapter 12, holder 10a, 10b and ultrasonic transducer 11, 14. The circumferential frame 8 clips together with a base plate, not shown, which extends parallel to the printed circuit board 6.

FIG. 2 shows the “interior” of the device 1 in an extracted view. The above-mentioned printed circuit board 6 can be identified, on which a control device 9, not shown in further detail, is constructed, which is used for the control and analysis of ultrasonic transducers and by means of which, in response to an analysis result in a manner known per se, a light of a lighting system can be activated, in particular switched on and off.

The printed circuit board 6, oriented parallel to a base surface of the device 1, is the carrier for a total of four holders at the same time, of which only one pair of holders 10a, 10b is shown. The holders 10a, 10b are fixed on the printed circuit board 6 and each forms a cavity for receiving one ultrasonic transducer 11 each, shown in FIG. 4 (ultrasonic capsule or ultrasonic oscillator). The ultrasonic transducers 11 can be driven as a transmitter or receiver of ultrasonic waves in a manner known per se, via the control device 9.

The ultrasonic transducers 11 are oriented such that a main emission direction and a main reception direction of ultrasonic waves extend at an angle, in the exemplary embodiment shown forming an angle of approximately 30° to the surface extension of the printed circuit board 6.

As already mentioned, ultrasonic transducers 11 are received in the holders 10a, 10b. On each of the holders 10a, 10b, which can be formed as separate injection-moulded parts or as a common injection-moulded part made of plastic, sits a sleeve-shaped adapter 12, which with its internal circumference forms the boundary of a resonant cavity.

On the side facing away from the associated ultrasonic transducer 11, a horn 3a, 3b adjoins each adapter 12. In the configuration shown in FIG. 2, one of the ultrasonic transducers 11 is configured as an ultrasonic transmitter and the neighbouring ultrasonic transducer 11 as a receiver, or activated via the control device 9. This means that one of the two ultrasonic transducers 11 emits an ultrasonic wave signal, with the reflections being received by the respective other ultrasonic transducer. The mechanical structure, or the geometries, of the two resonant cavities and horns 3a, 3b, are identical.

From FIG. 2, one of the two lateral housing shells 4 which form the horns 3a, 3b of a first horn pair can also be seen.

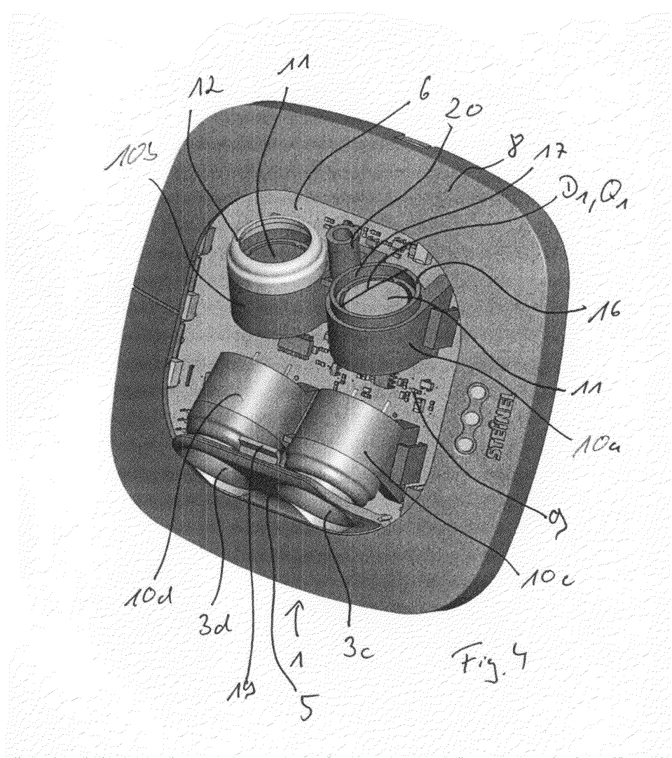

FIG. 3 shows a schematic cross-sectional view of the structure of an ultrasonic transmitter, in which the geometrical configuration of the transmitter and receiver are identical. The circuit board 6 can be seen with the holder 10a fixed thereon, which in its interior forms a cavity 13 for an ultrasonic transducer 14, which can be inserted from the opening side to facilitate assembly. The ultrasonic transducer 14 with electrical connections 15 projects backwards in the direction of the printed circuit board 6 and is electrically contacted there (not shown).

The holder 10a extends axially beyond the ultrasonic transducer 14 in the emission direction with an annular protrusion 16. This is axially overlapped by a sleeve-shaped adapter 12, which together with the annular protrusion 16 forms the boundary of the resonant cavity 17. This is cylindrically contoured along the whole of the axial extent, and has a maximum cross-sectional area of approximately 327 mm². The maximum cross-sectional extension in this exemplary embodiment also corresponds to the central cross-sectional extension.

It can be seen that the maximum cross-sectional area of the resonant cavities 17, which extends perpendicular to the main emission direction, is greater than the maximum cross-sectional area of the ultrasonic transducer 11.

On the opposite side of the resonant cavity 12 to the ultrasonic transducer 11, the former is bounded by the horn 3a formed in the lateral housing shell 4, which opens to the outside in the shape of a trumpet. The horn 3a protrudes axially into the adapter 12 and in the transition region between resonant cavity 17 and horn 3a, bounds an impedance cross-sectional area 18 which is less than the maximum cross-sectional area of the resonant cavity 17 and also less than the maximum cross-sectional area of the ultrasonic transducer 14.

The constructional design of the device 1 is clear from FIG. 4. Clearly visible is the printed circuit board 6 surrounded by the housing frame 8 with the control device 9 constructed thereon. The mounting brackets 10a to 10d for the ultrasonic transducers 11 are fixed on the printed circuit board 6, each ultrasonic transducer 11 being overhung by the annular protrusion 16 of the associated holder 11. The annular protrusions 16 are axially overlapped by sleeve-shaped adapters 12, with which the horns 3a and 3b engage. In FIG. 4 a locking tab 19 can be seen, for fixing the lateral body shell 5 on the central housing shell 7, not shown in FIG. 4. In addition, the housing shells 4, 5 engage in the retaining sleeves 20 formed on the holders 10a to 10d.

From FIG. 4 two pairs of ultrasonic transducers 11 can be readily identified, each with an associated resonant cavity and horn. All these resonant cavities and horns are geometrically equal in size, wherein in each case one ultrasonic transducer of a pair is used as a transmitter and the other as a receiver of reflected ultrasonic waves.

In FIG. 4 an example diameter D1 is drawn in, here with a value of approximately 20.4 mm in the region of the maximum cross-sectional area Q1 of a resonant cavity 17.

In comparison to this, from FIG. 2 a diameter D2, here with a value of about 10.0 mm, of the associated impedance opening 21 is obtained, the cross-sectional area of which is approximately 78.5 mm² and thus less than the maximum cross-sectional area of approximately 327 mm² of the resonant cavity 17. The ratio of the cross-sectional areas is 0.24.

1. An ultrasonic motion sensor device for lighting control, comprising a housing, at least one ultrasonic transducer arranged in the housing for sending and/or receiving ultrasonic waves through an opening in the housing associated with the ultrasonic transducer, and a control device associated with the ultrasonic transducer, wherein the opening in the housing is formed by a horn which is spaced apart from the ultrasonic transducer via a resonator cavity arranged in the housing, and an impedance opening is bounded by the horn, wherein emitted and/or received ultrasonic waves are passed through the impedance opening, the impedance opening has a cross-sectional area which is less than a maximum cross-sectional area of the resonant cavity and less than a maximum cross-sectional area of the horn.

2. The device according to claim 1, wherein the maximum cross-sectional area of the resonant cavity is formed by a cylindrical section of the resonant cavity, which extends over at least 75% of the longitudinal extension of the resonant cavity.

3. The device according to claim 1, wherein a cross-sectional area ratio between the cross-sectional area of the impedance opening and the maximum cross-sectional area of the resonant cavity is chosen from a range of values between 0.20 and 0.30 at an ultrasonic frequency of the ultrasonic transducer from a range of values between 35 kHz and 45 kHz.

4. The device according to claim 1, wherein a cross-sectional area ratio between the cross-sectional area of the impedance opening and the maximum cross-sectional area of the resonant cavity is chosen from a range of values between 0.22 and 0.26 at an ultrasonic frequency of the ultrasonic transducer from a range of values between 35 kHz and 45 kHz.

5. The device according to claim 1, wherein a cross-sectional area ratio between the cross-sectional area of the impedance opening and the maximum cross-sectional area of the resonant cavity is 0.24 at an ultrasonic frequency of the ultrasonic transducer of 40 kHz.

6. The device according to claim 1, wherein a holder for the ultrasonic transducer is fixed onto a printed circuit board of the control device.

7. The device according to claim 1, wherein the resonant cavity, at least in some sections, is bounded by an adapter piece which is arranged between the horn and the ultrasonic transducer.

8. The device according to claim 7, wherein at least one of the adapter is pushed onto the holder for the ultrasonic transducer and the horn is pushed onto the adapter.

9. The device according to claim 1, wherein the horn is formed in a plastic housing shell.

10. The device according to claim 1, wherein a first pair of ultrasonic transducers, arranged next to each other and spaced apart, are each provided with an associated resonant cavity and horn, wherein the horns are oriented at least approximately in a common first direction and one of the ultrasonic transducers is configured as an ultrasound transmitter and the other ultrasonic transducer as an ultrasound receiver.

11. The device according to claim 10, wherein on a side of the housing facing away from the first pair of ultrasonic transducers is a second pair of ultrasonic transducers arranged next to each other and spaced apart, wherein each of the second pair of ultrasonic transducers is provided with an associated resonant cavity and horn, wherein the horns are oriented at least approximately in a common second direction and one of the ultrasonic transducers is configured as an ultrasonic transmitter and the other ultrasonic transducer as a receiver.

12. The device according to claim 11, wherein the first and the second direction enclose an angle between 100° and 170°.

13. The device according to claim 11, wherein at least one of the first pair of horns and the second pair of horns is constructed in a common housing shell and that the common housing shell is clipped onto one of a frame part and a printed circuit board by means of another housing shell.

14. Lighting system comprising an ultrasonic motion sensor device and at least one lamp, which can be switched on and/or off by means of the ultrasonic motion sensor device.
